(19) United States
(12) Patent Application Publication
(10) Pub. No.: US 2003/0134672 A1
(43) Pub. Date: Jul. 17, 2003

(54) Lottery game

(75) Inventor: Stanley E. Fulton, Las Vegas, NV (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: Lotto World, L.L.C., Las Vegas, NV (US)

(21) Appl. No.: 10/331,455

(22) Filed: Dec. 30, 2002

Related U.S. Application Data
(60) Provisional application No. 60/348,807, filed on Jan. 15, 2002.
(60) Provisional application No. 60/365,562, filed on Mar. 19, 2002.

(51) Int. Cl. A63F 13/00

(52) U.S. Cl. 463/17

(57) ABSTRACT

A method of playing a lottery game on a gaming machine is provided that includes the steps of inputting at least one credit into the gaming machine to play at least one lottery game, selecting a set of lottery numbers for entry into a traditional lottery game, playing an instant-win lottery game, awarding a prize value for the instant-win lottery game, and printing a lottery ticket having information including the set of lottery numbers.

### CROSS-REFERENCES TO RELATED APPLICATIONS

This application claims the benefit of U.S. Provisional Application No. 60/348,807, entitled Method of Playing a Lottery Game, filed Jan. 15, 2002 and U.S. Provisional Application Serial No. 60/365,562, entitled Lottery Game, filed Mar. 19, 2002.

### BACKGROUND OF THE INVENTION

1. Field of Invention

The present invention pertains to lottery games, in general, and to electronic lottery games, in particular. More particularly, the present invention is directed to a gaming system such as a video lottery system that combines elements of both a traditional lottery game and an instant-win type lottery game. 2. Description of Related Art

Slot machines have become increasingly popular with players in many legalized gaming establishments. In some jurisdictions, however, legal restrictions on gaming machines have made it impossible to put traditional type slot machines into play in certain gaming facilities. Many of those jurisdictions, however, will permit lottery terminals to be used by players to participate in lottery draws.

In these jurisdictions, it is desirable to provide devices that have the excitement of electronic gaming machines while adhering to lottery principles. Such a game would add to the excitement and fun that a player may experience in legalized gaming establishments that are subject to prohibitions on the use of traditional slot machines.

There are known “traditional” lottery games where tickets are sold for a periodic lottery award drawing, for example, a weekly drawing. The periodic drawing may be a “progressive” type drawing, as known, where the award prize increases with the number of tickets purchased toward that particular drawing.

There are known “instant-win” lottery games that include, for example, scratch-off portions of a ticket that allow a player to immediately determine if he or she has a winning ticket. Instant-win type lottery games are also known in which a player plays the game at, for example, a video terminal, and any amount awarded as a prize is printed or encoded on a ticket which is ejected from the terminal after each play. An advantage of instant games is that a player knows instantly whether or not he or she has won a prize.

However, the combination of the instant-win type lottery and a traditional lottery has been made that is played in a single game play.

### BRIEF SUMMARY OF THE INVENTION

A method of playing a lottery game on a gaming machine is provided which includes the steps of inputting at least one credit into the gaming machine to play at least one lottery game, selecting a set of lottery numbers for entry into a traditional lottery game, playing an instant-win lottery game, awarding a prize value for the instant-win lottery game, and printing a lottery ticket having information including the set of lottery numbers.

The step of inputting at least one credit may include associating at least one credit with a card and inserting the card into the gaming machine. The steps of inputting, selecting, playing and awarding may occur a plurality of times and the step of may printing occur after the plurality of times. The step of printing the lottery ticket may include printing a ticket having information including the prize value for any instant-win lottery games played. The step of inputting credits may include remotely accessing a player's account. The step of printing the lottery ticket may occur after each lottery game is played. The step of printing the lottery ticket may occur after a plurality of lottery games are played and the lottery ticket may be printed with information with respect to a plurality of lottery games. The step of awarding a prize value for the instant-win lottery game may include inputting credits equal to the prize value into the gaming machine to play additional lottery games. A step of requesting a voucher equal to accumulated prize values for the instant-win lottery games played may also be included. The step of printing may include printing a ticket with a total prize value for all instant-win lottery games after the plurality of lottery games are played. The step of awarding a prize value for the instant-win lottery game may occur only after a plurality of lottery games is played and a certain random event occurs.

In an alternate embodiment of the present invention, a method of playing a lottery game on a gaming machine is provided which includes the steps of inputting at least one credit into the gaming machine to play at least one lottery game, selecting a set of lottery numbers for entry into a traditional lottery game, playing an instant-win lottery game, awarding a prize value for the instant-win lottery game, and associating a value with a card having information including the set of lottery numbers.

A step of printing a ticket having information including the prize value for the instant-win lottery game may be included. The step of inputting credits may include remotely accessing a player's account. The step of associating the value with the card may occur after each lottery game is played or, the step of associating the value with the card may occur after a plurality of lottery games are played and the card is associated with information with respect to the plurality of lottery games. The step of awarding a prize value for the instant-win lottery game may include inputting credits equal to the prize value into the gaming machine to play additional lottery games. The step of awarding a prize value for the instant-win lottery game may occur only after a plurality of lottery games is played and a certain random event occurs.

In another alternate embodiment of the present invention, a method of playing the lottery game includes the steps of providing a lottery number selection device, a credit input device, a player input device, a ticket printer, and a ticket output device, inputting credits into the credit input device in an amount adequate to play at least one lottery game, selecting a set of lottery numbers for entry into a traditional lottery game using the player input device, playing an instant-win lottery game, and assigning a value based on a prize value awarded in the instant-win lottery game. The steps of selecting, playing and assigning may be repeated. Finally, this embodiment includes the step of printing a lottery ticket having indicia including the sets of lottery numbers obtained.

The step of providing the credit input device may include providing a reader for obtaining access to the player's account. The step of providing the reader may include providing a credit card, smart card, debit card, biometric analyzer and the like to access the player's account. The step of printing the lottery ticket may occur after each lottery game is played. The step of printing the lottery ticket may occur after a plurality of lottery games are played. Here, the lottery ticket contains indicia with respect to a plurality of lottery games. The step of assigning the value based on the prize value awarded in the instant-win lottery game may include the step of assigning the value based on the prize value that is awarded only after a plurality of lottery games is played and a certain random event occurs.

In another alternate embodiment of the present invention, a method of playing a lottery game is provided which includes the steps of providing a lottery number selection device, a credit input device, a player input device, a ticket printer, a ticket output device, and a credit button, inputting credits into the credit input device in an amount adequate to play one or more lottery games, selecting a set of lottery numbers for entry into a traditional lottery game using the player input device, playing an instant-win lottery game, and assigning a value based on a prize value awarded in the instant-win lottery game. The value is automatically paid to a credit meter to allow play of additional lottery games. The step of printing a lottery ticket having indicia including the at least one lottery number. The credit button may be accessed at any time, wherein accessing the credit button causes issuance of all credits due to the player.

The step of accessing the credit button may cause issuance of a card having associated therewith all the credits due the player. The step of accessing the credit button causes issuance of a ticket having associated therewith all the credits due the player. The step including providing the credit input device may include providing a reader for obtaining access to the player's account. The step of providing the reader may include providing a credit card, smart card, debit card, biometric analyzer and the like to access the player's account. The step of printing the lottery ticket may occur after each lottery game is played or after a plurality of lottery games are played. Here, the lottery ticket contains indicia with respect to a plurality of lottery games. The step of assigning the value based on the prize value awarded in the instant-win lottery game may include the step of assigning the value based on the prize value that is awarded only after a plurality of lottery games is played and a certain random event occurs.

In another alternate embodiment of the present invention, a method of playing a lottery game on a gaming system is provided which includes the steps of providing a player card capable of having encoded information stored thereon, encoding a value of credits onto the card, inputting the card into the gaming system, deducting a play value from the card, selecting a set of lottery numbers for entry into a traditional lottery game and playing an instant-win lottery game. The method further includes the steps of assigning a value based on a prize value awarded in the instant-win lottery game, encoding the value on the card, continuing to deduct additional play values, continuing to select sets of lottery numbers and continuing to play the instant-win lottery game for a desired number of plays, and withdrawing the card from the gaming system. The card will have stored thereon the at least one set of lottery numbers and remaining credits, including accumulated prize values awarded.

The step of providing an apparatus having a lottery number selection device, a card reader/writer, and a player input device may be included. The step of outputting a printed list of the sets of lottery numbers stored on the card may also be included. The step of assigning the value to a lottery ticket based on the prize value awarded in the instant-win lottery game may include the step of assigning the value based on the prize value that is awarded only after a plurality of lottery games is played and a certain random event occurs.

Finally, in another alternate embodiment of the present invention, a method of playing a lottery game is provided which includes the step of providing an apparatus having a lottery number selection device, a card reader/writer, and a player input device. The method further includes the steps of providing an encodable player card capable of having encoded information stored thereon, encoding a value of credits onto the card, inputting the card into the card reader/writer, and deducting a play value from the card using the card reader/writer. The method further includes the steps of selecting a set of lottery numbers for entry into a traditional lottery game using the player input device and storing the set of lottery numbers on the card using the card reader/writer, playing an instant-win lottery game, and assigning a value based on a prize value awarded in the instant-win lottery game. The value is encoded on the card using the card reader/writer. Additional play values are deducted from the card, sets of lottery numbers are selected, and play of the instant-win lottery game is continued for a desired number of plays. The card is withdrawn from the card reader/writer after the desired number of plays is completed or after all the value on the card has been exhausted where the card has stored thereon the at least one set of lottery numbers and remaining credits, including accumulated prize values awarded. The card is input into a money output/ticket printer device and money is output from the money output/ticket printer device in an amount equal to the accumulated prize values awarded on the card. Finally, a printed list of the sets of lottery numbers stored on the card is output.

The step of encoding the value of credits onto the card may include using a device that is separate and independent of the apparatus having a lottery number selection device, a card reader/writer, and a player input device. The step of assigning the value to a lottery ticket based on the prize value awarded in the instant-win lottery game may include the step of assigning the value based on the prize value that is awarded only after a plurality of lottery games is played and a certain random event occurs.

### BRIEF DESCRIPTION OF SEVERAL VIEWS OF THE DRAWINGS

The invention will be described in conjunction with the following drawings wherein like reference numerals designate like elements throughout the several views and wherein:

FIG. 1 is a simplified schematic diagram of a method for playing a lottery game in accordance with one preferred embodiment of the present invention;

FIG. 2 is a simplified front, elevational view of an example of a lottery system player terminal used in accordance with the method of FIG. 1;

FIG. 3 is a simplified schematic diagram of a method for playing a lottery game in accordance with another preferred embodiment of the present invention;

FIG. 4 is a simplified front, elevational of an example of a lottery system player terminal used in accordance with the method of FIG. 3; and

FIG. 5 is a simplified schematic diagram of an example of a lottery system card encoding apparatus used in accordance with the method of FIG. 3.

### DETAILED DESCRIPTION OF THE INVENTION

The present invention is directed to a lottery game that provides a player with high levels of entertainment and excitement as compared to traditional lottery games.

The present invention includes a first aspect directed to a traditional lottery system where, periodically, for example, one time per week, one or more winning sets of numbers is selected by a lottery operating organization and one or more jackpot winners are determined based on a comparison of the winning sets of numbers with individual lottery ticket numbers. The individual lottery ticket numbers are either player selected or selected by a “quick-pick” feature at the point of purchase, where random lottery ticket numbers are automatically generated. A second aspect of the present invention is directed to an “instant-win” type lottery that is applied in combination with the above, traditional style lottery in a unique manner.

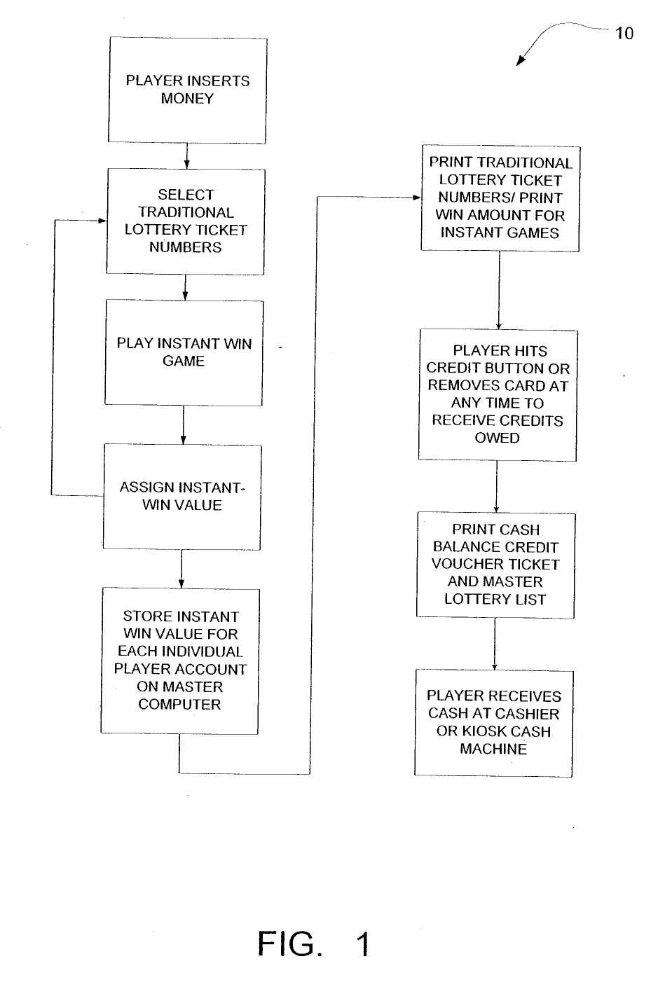

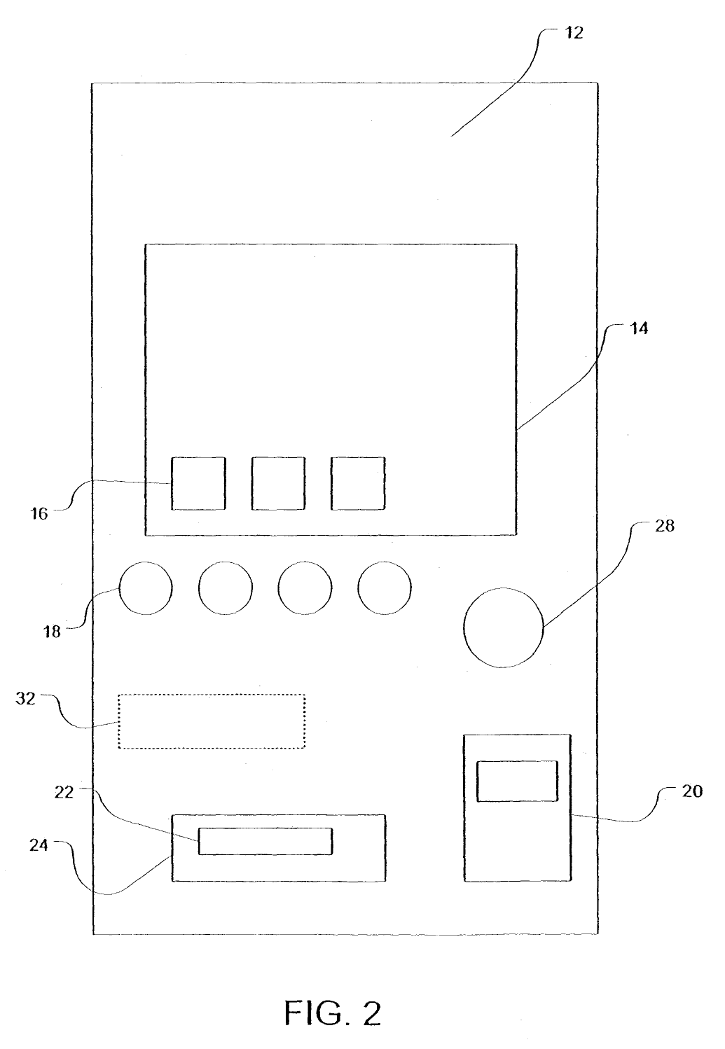

Referring now to the drawing figures wherein like part numbers refer to like elements throughout the several views, there is shown in FIG. 1, a schematic of a method for playing a lottery game 10 in accordance with one preferred embodiment of the present invention. The method for playing a lottery game 10 utilizes a player terminal 12, an example of which is shown in FIG. 2. The player terminal 12 preferably includes a display 14, a lottery number selection device which may be in the form of touch screen icons 16 on the display 14, or buttons 18 or the like on the terminal 12, a credit input device 20, which may include a card or biometric reader for access to a player's credit, debit, or other account, other player input devices, which also may be in the form of a icons 16 or buttons 18, a ticket printer 22, and a ticket output device 24. The ticket printer 22 and the ticket output device 24 may be integral to one another.

The player inserts credits (e.g., money) into the credit input device 20 in an adequate amount to purchase one or more tickets. The player terminal 12 will preferably display the amount required. Player buttons may be utilized for some or all of the touch screen functions and vice versa.

The display screen 14 then requests that the player use the buttons 18 or icons 16 to select one or more sets of lottery ticket numbers for each lottery ticket purchased. As is known in the lottery art, the terminal 12 can include a “quick-pick” button or touch screen icon 28 in which the player can request that the terminal 12 automatically select a set of lottery ticket numbers.

Any quantity of numbers may be used for the set of lottery ticket numbers (and winning set of numbers). For example, the set of numbers could include six sets of two digit numbers. Alternatively, the set of numbers could include, for example, between 1 and 10 sets of 1 to 100 digit numbers.

The method 10 may be used with substantially any type of traditional lottery. For example, the method may be used with a progressive lottery where a lottery jackpot is progressively increased until a set of lottery ticket numbers is identical to a set of winning lottery numbers.

As noted above, the method 10 also includes a second aspect directed to an “instant-win” type lottery that is applied in combination with the above, traditional style lottery. Here, after each set of traditional lottery ticket numbers is selected by a player, an instant-win lottery game is played. Here, the lottery ticket numbers, as selected above, may be used, new numbers may be used, or a game may be played without player selection of any numbers may be used. Any type of instant-win lottery video style game may be played whether or not they are based on selected numbers. Again, if new numbers are to be selected, they may be selected by the user or automatically selected using a quick-pick feature.

In one preferred embodiment, after the lottery numbers for the traditional lottery are selected, the display transitions into an instant-win game. Here, for example, an “instant-win” winning lottery number generator will display a random selection of bonus screens.

The instant-win lottery may be in the form of a game. For example, the winning lottery number generator may be in the form of a game in which the player provides input into the player input device to assist the winning lottery number generator in generating the winning lottery numbers. For example, a set of fifty numbered squares can be displayed on the display screen 14. Associated with each numbered square is, for example, a random two digit number and five L-O-T-T-O squares. The player selects, for example, six squares. Once the player selects the squares, the two digit numbers associated with the selected squares becomes visible to the player. The two digit numbers are added up and compared to an award table for instant-win credits. If L-O-T-T-O is displayed, a Mini-Lotto progressive could be won.

The instant win game can optionally be made to award cash prizes upon playing a series of instant win games wherein the award is not made until a certain random event occurs. That is, each time the instant-win game is played, the player receives another “piece” of numerous pieces that is required to win a larger jackpot. For example, a player may receive one out of six pieces of a puzzle for each game play. The system keeps track of the value of the various pieces of the puzzle. In order to win this version of the instant win game, all six puzzle pieces must be received that all fit together properly. While it may be theoretically possible to win the instant win game after only six plays, the odds of winning are likely to be made much higher so that a large instant win jackpot would be infrequently awarded. Of course, this version of the instant win game need not be in the form of a puzzle, as described above. Any game where play proceeds in a series until a certain event occurs in order for an award to be made is intended to be included here. That certain event may occur frequently or may occur extremely infrequently, for example, on one out of every ten million or more plays.

At this point, as can be seen in FIG. 1, any winning awarded in the instant win game are paid back to the terminal and new lottery number selections are made. At any time, the player can ask for the accumulated amount of the instant pick lottery, if any, to be printed out on the lottery ticket along with the selected numbers for the traditional lottery. The ticket may then be cashed for its value, but the numbers selected for the traditional lottery remain on the original ticket. The ticket may be cashed for value at an automatic cash kiosk or by a cashier. The player still has the opportunity to win the “traditional” lottery since the lottery numbers are also printed on the lottery ticket and the player retains the ticket.

If nothing is won on the instant-win lottery game, a ticket with the set of traditional lottery ticket numbers is printed. The ticket also have indicia indicating “no win” with respect to the instant-win lottery.

Another preferred option is as follows. After the traditional lottery numbers are selected and the instant-win lottery games are played, the machine again prints a ticket. Here, indicia on the ticket indicates the set of lottery numbers selected for the traditional lottery. If there are credits won on the instant-win lottery game, they are automatically paid to the terminal. The ticket is printed with the set of traditional lottery numbers thereon and also includes indicia indicating “X credits (or X dollars) were paid to terminal”, for any credits/dollars won in the instant-win lottery. The player uses these credits/dollars for additional game plays which each consist of one traditional lottery and one instant-win lottery game.

Optionally, but not necessarily preferably, a ticket may be printed after each game play. Each game play consists of one traditional lottery game and one instant-win lottery game. Here, each ticket contains indicia indicating, among other things, the set of traditional lottery ticket numbers selected for the traditional lottery. The ticket output device 24 then delivers the ticket having the indicia printed thereon to the player. The ticket printer 22 would print indicia using, for example, a thermal printer or may otherwise be electronically encoded, for example, with a bar code or magnetic strip.

At any time, if a player has credits owed to him or her, as described above, the player may hit a “pay credit” button 30 and receive a printed voucher that is printed or encoded with a cash balance. The player may take this voucher to a cashier to obtain cash, or take the voucher to a kiosk wherein the player may insert the voucher and receive cash for the amount he or she is owed.

The ticket may identify, for example, the player's lottery ticket number, a game identifier, an amount of wager, date and time of transaction, and, among other things, an identification number for the player terminal utilized by the player. The lottery ticket may be used as a bearer instrument for verification and redemption of winnings.

All tickets sold would then be entered into a competition for a traditional lottery jackpot or set of jackpots.

The above embodiments are also equally applicable to play with credit cards, debit cards, smart cards and the like as well as with any other type of cashless system known. That is, the credit input device may accept, for example, all of the above, as well as coins or tokens.

It is noted that the terminal 12 can be any type of terminal and is not limited to a free standing commercial terminal. For example, the terminal 12 can be a home computer where icons 16 can be accessed, for example, via a keyboard, the credit input device can be a means to insert, for example, a credit card number. This can be accomplished by manually typing in the required information. The ticket printer 22 and ticket output device 24 can be in the form of, for example, a standard personal computer printer. All required software, such as for the instant-win lottery number generator, can be accessed via a network such as the internet.

For purposes of the present invention, the indicia printed on the ticket may include, for example, printing, bar codes, magnetic strips or any other type of electronic coding.

In an alternate embodiment, the terminal 12 may store multiple lottery ticket selections and print out a single (or more than one) ticket when a predetermined number of selections are accumulated. A single ticket may be printed out, for example, when the presses the “pay credit” button 30, for example, when runs out of credits, or when the capacity of numbers on the ticket is reached.

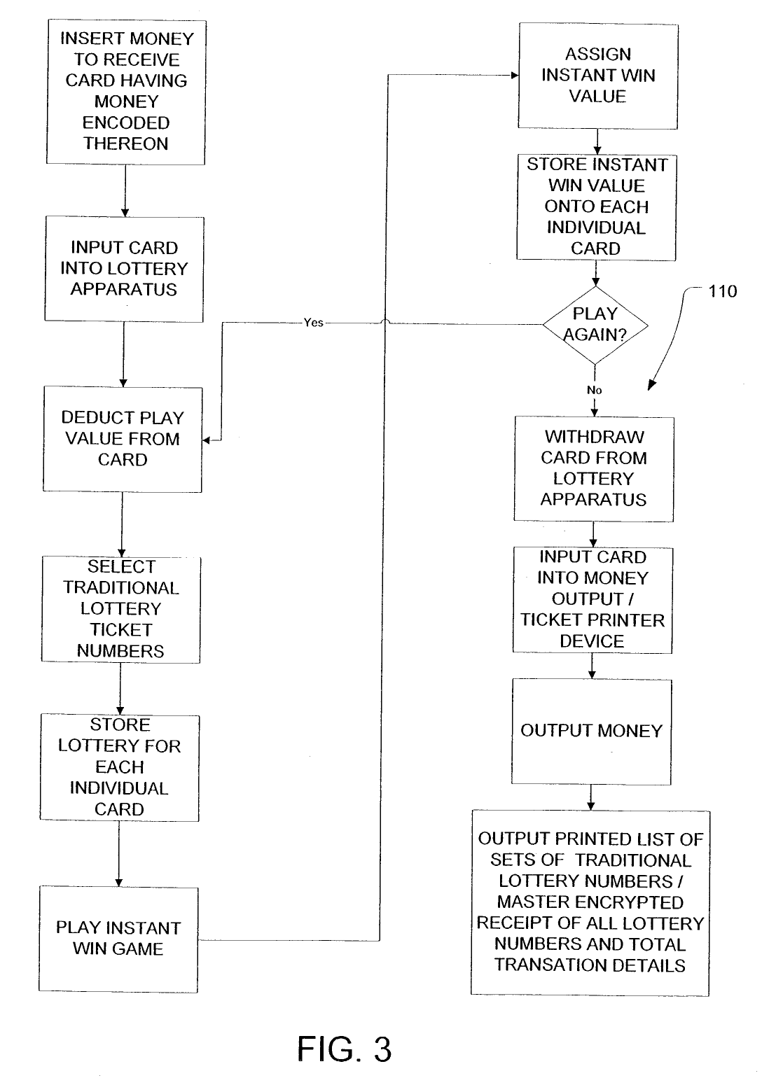

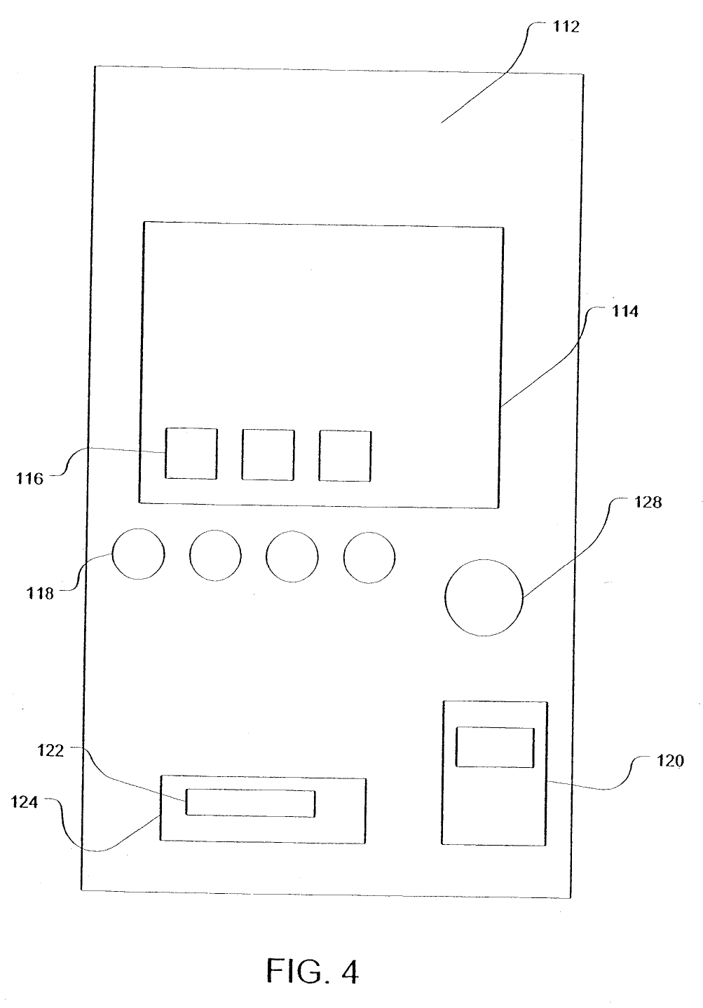

There is shown in FIG. 3, a schematic of a method for playing a lottery game 110 in accordance with another preferred embodiment of the present invention. The method for playing a lottery game 110 of FIG. 3 utilizes a player apparatus such as a player terminal 112, an example of which is shown in FIG. 4. The player terminal 112 preferably includes a display 114, a lottery number selection device which may be in the form of touch screen icons 116 on the display 114, or buttons 118 or the like on the terminal 112, a card reader 120, and other player input devices, which also may be in the form of a icons 116 or buttons 118.

As can be seen schematically in FIGS. 3-5, the player inserts credits (e.g., money), a credit card or the like into a card apparatus 130, which may or may not be integral to the player terminal 112, in an adequate amount to purchase one or more lottery tickets. The card apparatus 130 then encodes or otherwise associates the card with a databank and, if the card apparatus 130 is separate from the player terminal 112, dispenses the card to the player. The player then inputs the card into the card reader 120 of the player terminal 112.

The player terminal 112 then deducts from the value associated with the card the amount of credits required for one lottery play and the display screen 14 requests the player to use a lottery number selection device in the form of the buttons 18 or icons 16 to select one or more sets of lottery ticket numbers for each lottery ticket purchased. Again, as is known in the lottery art, the terminal 12 can include a “quick-pick” button or touch screen icon 128 in which the player can request that the terminal 112 automatically select a set of lottery ticket numbers. The traditional lottery is similar to that described above with respect to the first embodiment.

Optionally, the lottery ticket numbers may be associated with the card such that a printed list of the traditional lottery numbers may be obtained by presenting the card to, for example, a separate kiosk.

As noted above, the method 110 also includes a second aspect directed to an “instant-win” type lottery that is applied in combination with the above, traditional style lottery. Here, after each set of traditional lottery ticket numbers is selected by a player, an instant-win lottery game is played, as described above with respect to the first embodiment.

At this point, the player decides whether to play again. If the player decides to play again, he or she hits an appropriate touch screen icon 116 or button 118 on the terminal 112 to resume play. The player terminal 112 then deducts the value of credits required for one play from the value associated with the card and play resumes as above. Play continues in this manner indefinitely.

When the player decides to terminate play, the player hits an appropriate touch screen icon 116 or button 118 on the terminal 112. The card reader 120 then ejects the card. Now, the terminal may print a list of all sets of lottery numbers purchased or the card may otherwise have information associated with it (either through a computer network or by encoding on the card) information related to all sets of lottery numbers purchased. The card will also have associated with it any remaining amount of credits that was either awarded during the instant-win play and credits left over from that initially associated with the card.

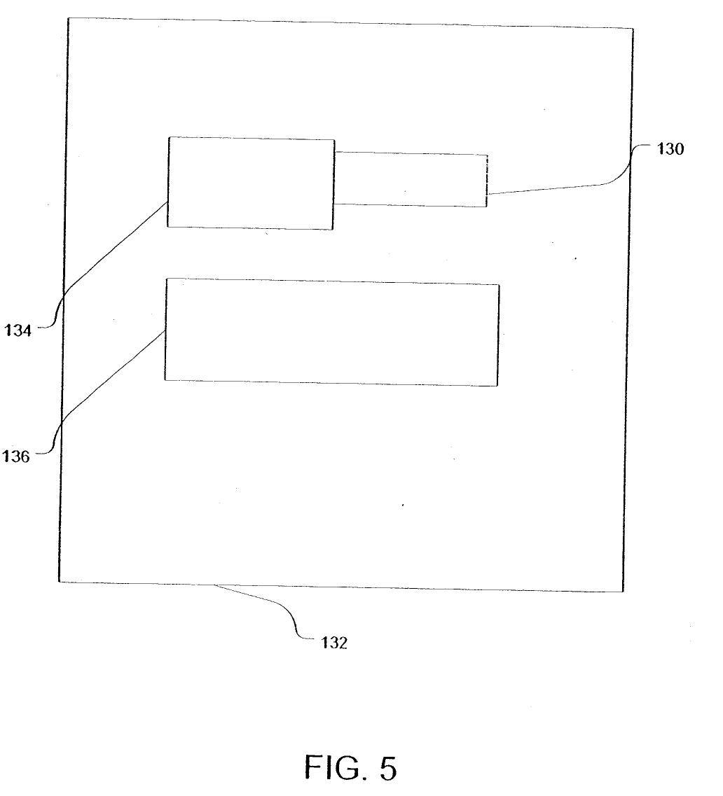

The card is then taken to a kiosk 132, i.e., a money output/ticket printer device, see FIG. 5, or the like (which may or may not include the card apparatus 130), as described above. The card is read by a card reader in 134 the kiosk 132 and remaining credits associated with that card (for example, as obtained through a computer network) are either output (as currency) to the player or a voucher is issued for the value of credits remaining on the card. If not previously printed at the terminal 120, a printer 136 in the kiosk 132 may then print a verified list of all sets of traditional lottery ticket numbers selected during play that have been encoded on the card.

All sets of lottery ticket numbers selected and printed on the verified list would then be entered into a competition for a traditional lottery jackpot or set of jackpots.

The above embodiments are also equally applicable to play with credit cards, debit cards, smart cards and the like as well as with any other type of cashless system known.

Although illustrated and described herein with reference to specific embodiments, the present invention nevertheless is not intended to be limited to the details shown. Rather, various modifications may be made in the details within the scope and range of equivalents of the claims without departing from the spirit of the invention.

What is claimed is:

1. A method of playing a lottery game on a gaming machine, comprising the steps of:
a) inputting at least one credit into the gaming machine to play at least one lottery game;
b) selecting a set of lottery numbers for entry into a traditional lottery game;
c) playing an instant-win lottery game;
d) awarding a prize value for the instant-win lottery game; and
e) printing a lottery ticket having information including the set of lottery numbers.

2. The method of playing a lottery game of claim 1, wherein the step of inputting at least one credit includes associating at least one credits with a card and inserting the card into the gaming machine.

3. The method of playing a lottery game of claim 1, wherein the steps of inputting, selecting, playing and awarding occur a plurality of times and wherein the step of printing occurs after the plurality of times.

4. The method of playing a lottery game of claim 1, wherein the step of printing the lottery ticket includes printing a ticket having information including the prize value for any instant-win lottery games played.

5. The method of playing a lottery game of claim 1, wherein the step of inputting credits includes remotely accessing a player's account.

6. The method of playing a lottery game of claim 1, wherein the step of printing the lottery ticket occurs after each lottery game is played.

7. The method of playing a lottery game of claim 1, wherein the step of printing the lottery ticket occurs after a plurality of lottery games are played and the lottery ticket is printed with information with respect to a plurality of lottery games.

8. The method of playing the lottery game of claim 1, wherein the step of awarding a prize value for the instant-win lottery game includes inputting credits equal to the prize value into the gaming machine to play additional lottery games.

9. The method of playing the lottery game of claim 1, including a step of requesting a voucher equal to accumulated prize values for the instant-win lottery games played.

10. The method of playing the lottery game of claim 1, wherein the step of printing includes printing a ticket with a total prize value for all instant-win lottery games after the plurality of lottery games are played.

11. The method of playing the lottery game of claim 1, wherein the step of awarding a prize value for the instant-win lottery game occurs only after a plurality of lottery games is played and a certain random event occurs.

12. A method of playing a lottery game on a gaming machine, comprising the steps of:
a) inputting at least one credit into the gaming machine to play at least one lottery game;
b) selecting a set of lottery numbers for entry into a traditional lottery game;
c) playing an instant-win lottery game;
d) awarding a prize value for the instant-win lottery game; and
e) associating a value with a card having information including the set of lottery numbers.

13. The method of playing a lottery game of claim 12, including the step of printing a ticket having information including the prize value for the instant-win lottery game.

14. The method of playing a lottery game of claim 12, wherein the step of inputting credits includes remotely accessing a player's account.

15. The method of playing a lottery game of claim 12, wherein the step of associating the value with the card occurs after each lottery game is played.

16. The method of playing a lottery game of claim 12, wherein the step of associating the value with the card occurs after a plurality of lottery games are played and the card is associated with information with respect to the plurality of lottery games.

17. The method of playing the lottery game of claim 12, wherein the step of awarding a prize value for the instant-win lottery game includes inputting credits equal to the prize value into the gaming machine to play additional lottery games.

18. The method of playing the lottery game of claim 12, wherein the step of awarding a prize value for the instant-win lottery game occurs only after a plurality of lottery games is played and a certain random event occurs.

19. A method of playing a lottery game, comprising the steps of:
a) providing a lottery number selection device, a credit input device, a player input device, a ticket printer, and a ticket output device;
b) inputting credits into the credit input device in an amount adequate to play at least one lottery games;
c) selecting a set of lottery numbers for entry into a traditional lottery game using the player input device;
d) playing an instant-win lottery game;
e) assigning a value based on a prize value awarded in the instant-win lottery game;
f) repeating the steps of selecting, playing and assigning; and
g) printing a lottery ticket having indicia including the sets of lottery numbers obtained.

20. The method of playing a lottery game of claim 19, wherein the step including providing the credit input device includes providing a reader for obtaining access to the player's account.

21. The method of playing a lottery game of claim 19, wherein the step of providing the reader includes providing a credit card, smart card, debit card, biometric analyzer and the like to access the player's account.

22. The method of playing a lottery game of claim 19, wherein the step of printing the lottery ticket occurs after each lottery game is played.

23. The method of playing a lottery game of claim 19, wherein the step of printing the lottery ticket occurs after a plurality of lottery games are played and the lottery ticket contains indicia with respect to a plurality of lottery games.

24. The method of playing the lottery game of claim 19, wherein the step of assigning the value based on the prize value awarded in the instant-win lottery game includes the step of assigning the value based on the prize value that is awarded only after a plurality of lottery games is played and a certain random event occurs.

25. A method of playing a lottery game, comprising the steps of:
a) providing a lottery number selection device, a credit input device, a player input device, a ticket printer, a ticket output device, and a credit button;
b) inputting credits into the credit input device in an amount adequate to play one or more lottery games;
c) selecting a set of lottery numbers for entry into a traditional lottery game using the player input device;
d) playing an instant-win lottery game;
e) assigning a value based on a prize value awarded in the instant-win lottery game, wherein the value is automatically paid to a credit meter to allow play of additional lottery games;
f) printing a lottery ticket having indicia including the at least one lottery number; and
g) accessing the credit button at any time, wherein accessing the credit button causes issuance of all credits due to the player.

26. The method of playing a lottery game of claim 25, wherein the step of accessing the credit button causes issuance of a card having associated therewith all the credits due the player.

27. The method of playing a lottery game of claim 25, wherein the step of accessing the credit button causes issuance of a ticket having associated therewith all the credits due the player.

28. The method of playing a lottery game of claim 25, wherein the step including providing the credit input device includes providing a reader for obtaining access to the player's account.

29. The method of playing a lottery game of claim 25, wherein the step of providing the reader includes providing a credit card, smart card, debit card, biometric analyzer and the like to access the player's account.

30. The method of playing a lottery game of claim 25, wherein the step of printing the lottery ticket occurs after each lottery game is played.

31. The method of playing a lottery game of claim 25, wherein the step of printing the lottery ticket occurs after a plurality of lottery games are played and the lottery ticket contains indicia with respect to a plurality of lottery games.

32. The method of playing the lottery game of claim 25, wherein the step of assigning the value based on the prize value awarded in the instant-win lottery game includes the step of assigning the value based on the prize value that is awarded only after a plurality of lottery games is played and a certain random event occurs.

33. A method of playing a lottery game on a gaming system, comprising the steps of:
a) providing a player card capable of having encoded information stored thereon;
b) encoding a value of credits onto the card;
c) inputting the card into the gaming system;
d) deducting a play value from the card;
e) selecting a set of lottery numbers for entry into a traditional lottery game;
f) playing an instant-win lottery game, assigning a value based on a prize value awarded in the instant-win lottery game, and encoding the value on the card;
g) continuing to deduct additional play values, continuing to select sets of lottery numbers and continuing to play the instant-win lottery game for a desired number of plays; and
h) withdrawing the card from the gaming system, the card having stored thereon the at least one set of lottery numbers and remaining credits thereon, including accumulated prize values awarded.

34. The method of playing a lottery game of claim 33, including the step of providing an apparatus having a lottery number selection device, a card reader/writer, and a player input device.

35. The method of playing a lottery game of claim 33, including the step of outputting a printed list of the sets of lottery numbers stored on the card.

36. The method of playing the lottery game of claim 33, wherein the step of assigning the value to a lottery ticket based on the prize value awarded in the instant-win lottery game includes the step of assigning the value based on the prize value that is awarded only after a plurality of lottery games is played and a certain random event occurs.

37. A method of playing a lottery game, comprising the steps of:
a) providing an apparatus having a lottery number selection device, a card reader/writer, and a player input device;
b) providing an encodable player card capable of having encoded information stored thereon;
c) encoding a value of credits onto the card;
d) inputting the card into the card reader/writer;
e) deducting a play value from the card using the card reader/writer;
f) selecting a set of lottery numbers for entry into a traditional lottery game using the player input device and storing the set of lottery numbers on the card using the card reader/writer;
g) playing an instant-win lottery game, assigning a value based on a prize value awarded in the instant-win lottery game, and encoding the value on the card using the card reader/writer;
h) continuing to deduct additional play values from the card, continuing to select sets of lottery numbers and continuing to play the instant-win lottery game for a desired number of plays;
i) withdrawing the card from the card reader/writer after the desired number of plays is completed or all the value on the card has been exhausted, the card having stored thereon the at least one set of lottery numbers and remaining credits thereon, including accumulated prize values awarded;
j) inputting the card into a money output/ticket printer device;
k) outputting money from the money output/ticket printer device in an amount equal to the accumulated prize values awarded on the card; and
l) outputting a printed list of the sets of lottery numbers stored on the card.

38. The method of playing a lottery game of claim 37, wherein the step of encoding the value of credits onto the card includes using a device that is separate and independent of the apparatus having a lottery number selection device, a card reader/writer, and a player input device.

39. The method of playing the lottery game of claim 37, wherein the step of assigning the value to a lottery ticket based on the prize value awarded in the instant-win lottery game includes the step of assigning the value based on the prize value that is awarded only after a plurality of lottery games is played and a certain random event occurs.
